(19) United States
(12) Patent Application Publication
(10) Pub. No.: US 2016/0300166 A1
(43) Pub. Date: Oct. 13, 2016

(54) SYSTEM FOR INTELLIGENT PROJECT DESIGN, INFORMATION STORAGE AND EXECUTION

(71) Applicant: Yunguang TONG, Los Angeles, CA (US)

(72) Inventor: Yunguang TONG, Los Angeles, CA (US)

(73) Assignee: QUICK BIOLOGY INC., Arcadia, CA (US)

(21) Appl. No.: 14/859,337

(22) Filed: Sep. 20, 2015

(30) Foreign Application Priority Data
Apr. 10, 2015 (CN) 201510169568.0

(51) Int. Cl. G06Q 10/06; G06F 17/30; H04L 29/08

(52) U.S. Cl. CPC G06Q 10/0635; H04L 67/02; H04L 67/10; G06F 17/30528

(57) ABSTRACT

A method of assisting the design and store of a research project includes the following steps: defining a sequence of predetermined protocol steps to be used by a researcher; in a first step, generating predetermined first prompts to guide the researcher to enter a protocol data corresponding to the first prompts; storing the entered protocol data in a first database having a structure which is at least partially predetermined; in a second step, generating second prompts to guide the researcher to enter a project data corresponding to the second prompts, and determining requirements for the retrieval of data from the first database; automatically retrieving selected protocol data from the first database, at least partially according to requirements of the second step; storing the selected protocol data and the project data in a second database for use in at least one further step of the method; and generating a project report including at least a portion of the selected protocol data and the project data.

The present invention claims the benefit of Chinese application no. 201510169568.0, filed on Apr. 10, 2015, which is hereby incorporated by reference in its entirety for all purposes as if fully set forth therein.

### BACKGROUND OF THE INVENTION

1. Field of the Invention

The present invention relates to a computer implemented system For project design, information storage and execution. The system can be used in every aspect of human life where a project is needed. It is particularly useful in scientific research. The system may advantageously be accessible within a network, such as a local area network, a wide area network, or the internet, in order to permit on-line access to a database through a search engine and to manage the application for such project and submission of resource.

2. Discussion of the Related Art

The internet is a worldwide system of connected computer networks, which enables computers of all kinds to share services and to communicate directly. The internet allows large commercial communications services as well as thousands of university, government and corporate computer networks and other computers to join together. Communications over the internet is accomplished by defined communication protocols. The World Wide Web is a subset of the internet which support the hypertext transfer protocol (HTTP), which is a common protocol for exchanging information. Such communication maybe interactive and is referred to as on-line.

Project design is quite common in daily life and. usually based on paperwork. There are different kinds of project design software in business management including workflow management.

However, these kinds of project design are usually not enough especially in scientific research field.

Scientific researches rely a lot on Protocols and also most all scientific projects are created by using protocols. Also a lot of material resources such as reagent and services are required in carrying out the research project. Finally, the project results need to be stored in a format related to protocol.

Invent “Method of assisting the conducting of a research project” (U.S. Pat. No. 6,041,303 A) described a method of assisting the conducting of a research project, in which a template is used to generate a research proposal. However, in scientific research, one of the most important things is to record research project results and make it easy to read and retrieve.

Here we invented a method to structure the protocols and projects information so that the protocols and projects results are easier to organize and project procedures to be understood by a program or machine, which will subsequently lead to improved project design, optimize and execute.

### SUMMARY OF THE INVENTION

It is an object of invention to provide a computer implemented system for project design, information structured storage, information match and projects execute optimization.

It is a further object of invention to provide a database of protocol templates.

It is a further object of invention to provide systematic standard to divide each protocol into steps and format the steps so that it can be properly interpreted by a program or equipment.

It is a further object of invention to provide a program that can interpret the protocols and projects designed using the said protocols.

It is a further object of invention to provide an on-line project design and information management system.

It is a further object of invention to provide an on-line system that use protocol template in project design.

It is a further object of invention to Store the projects as structured information so that projects can be compared to each other.

It is a further object of invention to provide an on-line project and project resource submission system.

It is a further object of invention to provide computer implemented system in project steps schedule optimization.

It is a further object of invention to match the resource, stored in memory, to the resource requirements generated in project execution, also in electronic readable memory.

It is a further object of invention to match the project information with past project information stored in memory, to check novelty or get experience.

It is a further object of invention to automatically re-arrange the project steps according to different criteria.

It is a further object of invention to provide an alarm system to notice project manager the progress of a project.

It is a further object of invention to allow better project outsourcing; said project designer let others to execute the project and input results.

It is a further object of invention to allow users to share or sale a resource.

It is a further object of invention to make projects understandable to at least one machine so that projects could be carried out automatically.

The invention may be implemented M a computer system whose actions are directed by a computer program configured as an information management system. The system includes databases stored in electronically readable memory. The system also includes a communication port suitable for transmitting and receiving data and instructions in the form of electrical signals, to and from remote computers and a database manager for creating and revising records of the databases. The system may also include an iterative database query engine connected to the memory and a process controller connected to the database manager, the interactive database query engine and the communication port. The project database records may contain a plurality of search key fields. The iterative database query engine may include means for searching on a plurality of search key fields of a database for satisfaction of one or more conditions and means for reporting all variables in said search key fields of records which satisfy the search conditions. The search key field may restrict the possible entries to a predetermined set of entries.

It is to be understood that both the foregoing general description and the following, detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an exemplary embodiment of protocol/project design and information structure storage system according to the present invention.

FIG. 2 illustrates an exemplary embodiment of information matching system according to the present invention.

FIG. 3 illustrates an exemplary embodiment of integrated project design, organize and cart out system according to the present invention.

FIG. 4 illustrates an exemplary embodiment of biological protocol/project structure storage according to the present invention.

FIGS. 5.1 and 5.2 illustrate an exemplary embodiment of biological protocol.

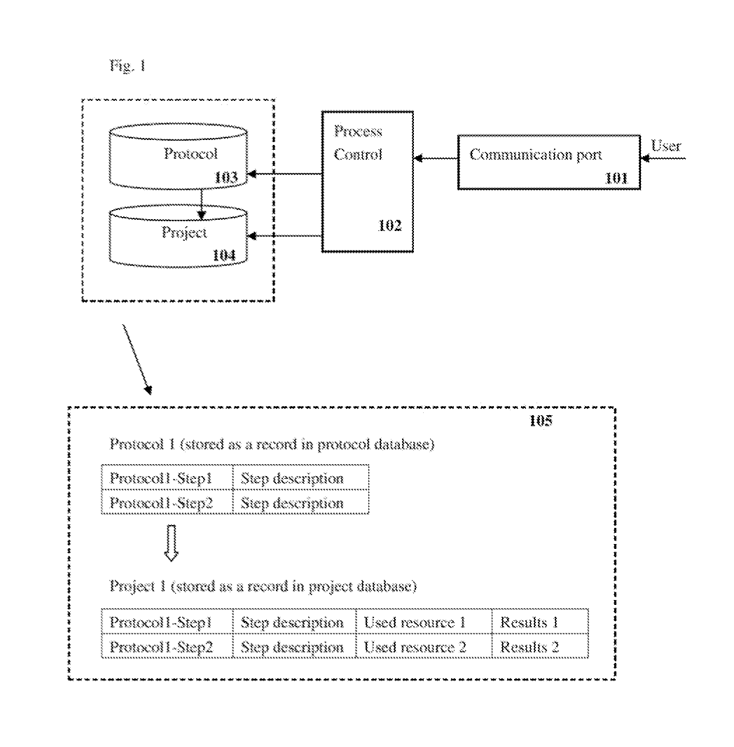

### DETAILED DESCRIPTION OF THE ILLUSTRATED EMBODIMENTS

Reference will now be made in detail to embodiments of the present invention, example of which is illustrated in the accompanying drawings.

The present invention may involve novel protocols, apparatus, message formats and/or data structures for facilitated project design, organize and carry out. The following description is presented to enable one skilled in the art to make and use the invention, and is provided in the context of particular applications and their requirements. Various modifications to the disclosed embodiments will be apparent to those skilled in the art, and the general principles set forth below may be applied to other embodiments and applications. Thus, the present invention is not intended to be limited to the embodiments shown and the inventors regard their invention as any patentable subject matter described.

The project mentioned in the present invention includes, but not limited to research projects.

It is to be understood that the system can be implemented using general purpose computer hardware as a network site. The general purpose hardware may advantageously be in the form of a windows workstation or other suitable computer. The hardware will be configured and customized by various software modules. The software modules will include communications software of the type conventionally used for Internet communication and a database management system. Any number of commercially available database management systems maybe utilized to implement the invention. Those of ordinary skill in the art of database management application programming will be able to make and use the invention according to the disclosure hereof.

In the following, a protocol/project design, information storage and management system and the exemplary embodiments of the present invention are described below. Then, an information matching system and its exemplary embodiments of the present invention are described below. A projects procedure optimizes system and its exemplary embodiments of the present invention are described below. An integration of project. design, organize and carry out system and its exemplary embodiments of the present invention are provided in below.

### A Project Design, Information Storage and Management System

According to the embodiments, a process control unit (102) will manage the flow of information through the system. A communication port (101) is provided to allow access to the network. According to the preferred embodiment, the network may include access over the internet to any number of external computer systems or access through local or wide area network to other connected computers either directly or through modems. The system will include database memory provided to store the databases.

The bases may be in the form of a data file comprised of a plurality of records, each record corresponding to a posted item. Each record will include a number of predefined fields containing parameters and additional fields containing descriptive information of the type generally used.

A user establishing access to the system according to the invention through the communication port (101) will be presented with a variety of menus. According to the preferred embodiment, communication may be effected through hypertext markup language (html) pages, ASP, PHP, JSP or other language pages.

The process control unit (102) passes information for the fields of the specified base from the user's computer through the communication port (101) into the selected database record. The bases are electronically stored databases. The bases are collection of records stored in electronically readable memory. The records advantageously includes fields specifying name, and narrative fields containing descriptive information, a description of key functions, and identification of a predetermined category, a specification of term according to literature, and a description of common usage. The fields in a record may be populated through use of a form presented to the user. The records may also include fields for a user password and a field that is used to designate the record as a submission to an accessible pool.

As discussed above, the system comprises two databases: protocols (103) and projects (104). When accessing the system a user is presented with an options menu. The options menu will also include the option of submitting a protocol/project to the protocol/project databases, searching the protocol/project base_{—} As with the option of maintaining the protocol/project base, the option of searching the protocol/project base may be restricted to authorized users selects the option of creating a protocol,

As shown in the 105, protocols in the protocol database may serve as a template for project design. A project manager may design new project records by using protocol structure by appending related project information recording parameters to protocol steps to enable structured project information storage_{—} The project information parameters

If the field designates a specified protocol/project, it may include a protocol/project record identification. The user will be presented the option of maintaining the protocol/project on the system without submission; submission of the protocol/project to a protocol/project pool accessible to others; In the event the protocol/project is submitted to an accessible pool; a mechanism may be provided to prevent access to the protocol/project by specified parties in order to protect private property. Access may be restricted by including a field in the protocol/project record identifying groups. An authorized researcher may also be presented with an option of retrieving, the protocol/project it has designed on the system.

The following are examples of apply the parameters to traditional protocols.

### EXAMPLE

### Biological Experiment (Western Blot)

### WESTERN PROTOCOL

### A. Preparation of Cell Lysates

1. Collect cells (confluent T-25) by trypsinization and spin.

2. Lyse the pellet, with 100 μl lysis buffer on ice for 10 min. For 500,000 cells, lyse with 20 μl.

3. Spin at 14,000 rpm (16,000 g) in an Eppendorf microfuge for 10 min at 4° C.

4. Transfer the supernatant to a new tube and discard the pellet.

5. Determine the protein concentration (Bradford assay, A280, or BCA) (We use the Bradford assay from Bio-Rad).

6. Take x μl(=y μg protein) and mix with x μl of 2× sample buffer.

7. Boil for 5 min.

8. Cool at RT for 5 min.

9. Flash spin to bring, down condensation prior to loading gel.

B. Using Precast Gels (Ready Gels from Bio-Rad):

1. Assemble gel in gel rig.

2. Prepare protein samples (10 μg will suffice).

3. Use 5 μl of Kaleidoscope standard.

4. Run at 200 V (constant voltage) for 30 min.

### C. Preparation of Membrane

1. Cut a piece of PVDF membrane (Millipore Immobion-P #IPVH 000 10).

2. Wet for about 30 min in methanol on a rocker at room temp.

3. Remove methanol and add 1× Blotting buffer until ready to use.

### D. Membrane Transfer

1. Assemble “sandwich” for Bio-Rad's Transblot.

2. Prewet the sponges, filter papers (slightly bigger than gel) in 1× Blotting buffer. Sponge×filter paper×gel×membrane×filter paper×sponge

3. Transfer for 1 hr at 1 amp at 4° C. on a stir plate. Bigger proteins might take longer to transfer. For the Mini-Transblot, it's 100 V for 1 hr with the cold pack and prechilled buffer.

4. When finished, immerse membrane in Blocking buffer and block overnight.

### E. Antibodies and Detection

1. Incubate with primary antibody diluted in blocking buffer for 60 min at room temp.

2. Wash 3×10 min with 0.05% Tween 20 in PBS.

3. Incubate with secondary antibody diluted in blocking buffer for 45 min at room temp.

4. Wash 3×10 min with 0.05% Tween 20 in PBS.

5. Detect with Amersham ECL kit (RPN 2106)

This formation of protocol is also hard to understand for new user and difficult to arrange the steps to save time. Also, people may have to check the resource manually and write a list to purchase stuff.

According to the invention, the designed platform can make this project much easier to carry out.

According to the invention, the protocol is divided into sequential steps.

Each step is formatted accord to the invention to let easier information extraction and project rearrangement.

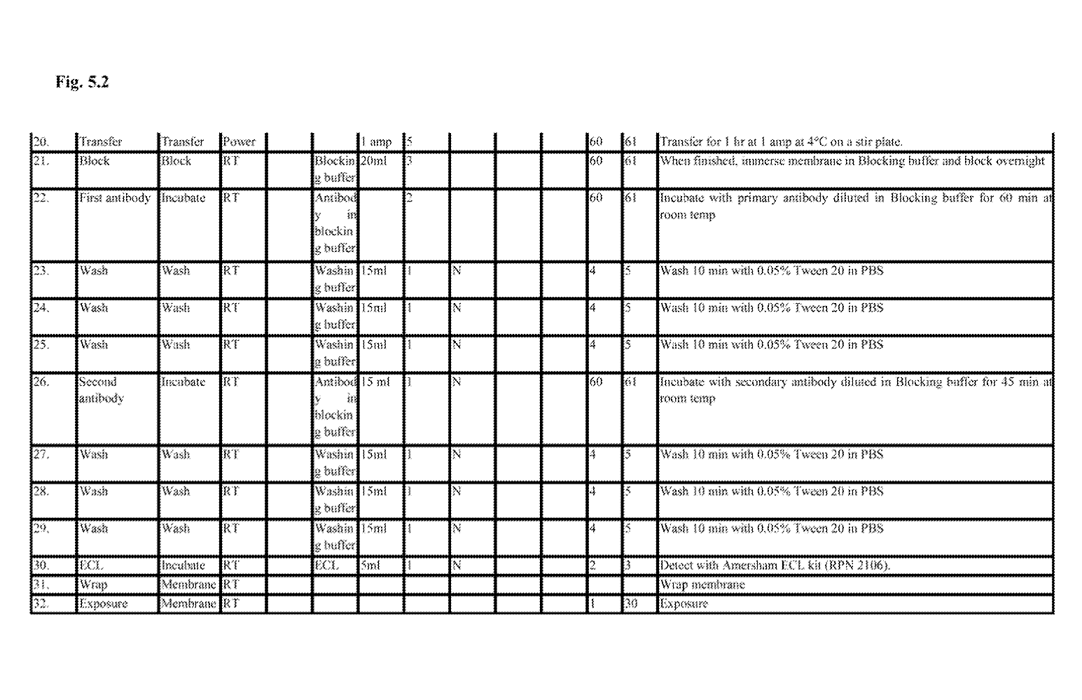

An example of the formatted protocol is displayed in FIG. 5.1 and 5.2.

### An Information Matching System

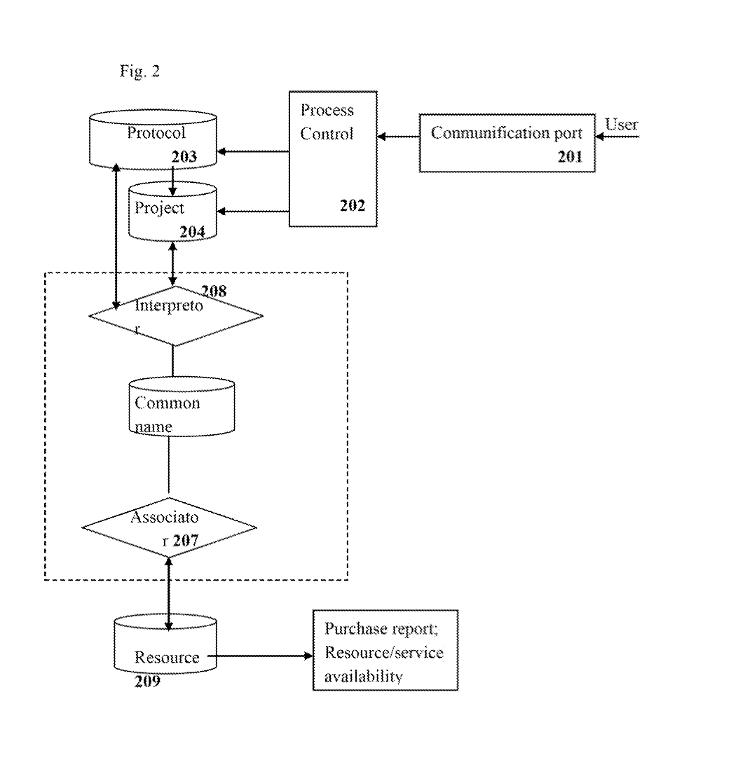

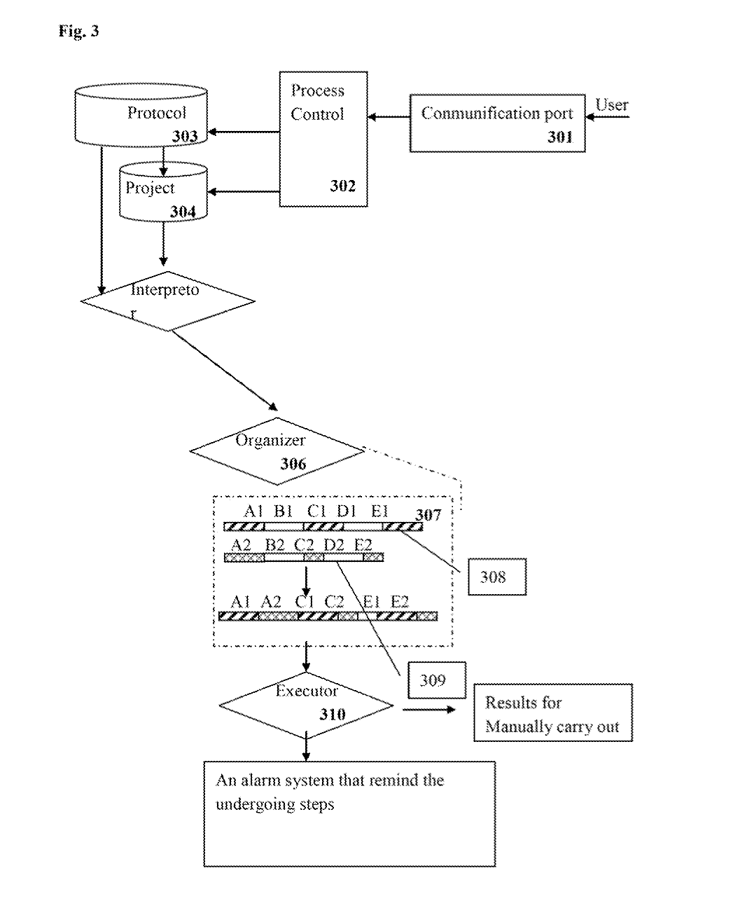

According to the embodiments FIG. 2, a process control unit (202) will manage the flow of information through the system. A communication port (201) is provided to allow access to the network. According to the preferred embodiment, the network may include access over the internet to any number of external computer systems or access through local or wide area network to other connected computers either directly or through modems. The system will include database memory provided to store the databases.

The bases may be in the form of a data file comprised of a plurality of records, each record corresponding to a posted item. Each record will include a number of predefined fields containing parameters and additional fields containing descriptive information of the type generally used.

A user establishing access to the system according to the invention through the communication port (201) will be presented with a variety of menus. According to the preferred embodiment, communication may be effected through hypertext markup language (html) pages, ASP, PHP, JSP or other language pages.

The process control unit (202) passes information for the fields of the specified base from the user's computer through the communication port (201) into the selected database record. The bases are electronically stored databases. The bases are collection of records stored in electronically readable memory. The records advantageously includes fields specifying name, and narrative fields containing descriptive information, a description of key functions, and identification of a predetermined category, a specification of term according to literature, and a description of common usage. The fields in a record may be populated through use of a form presented to the user. The records may also include fields for a user password and a field that is used to designate the record as a submission to an accessible pool.

As discussed above, when accessing the system a user is presented with an options menu. The options menu will also include the option of submitting a protocol/project to the protocol/project database (203, 204), searching the protocol/project base. As with the option of maintaining the protocol/project base, the option of searching the protocol/project base may be restricted to authorized users selects the option of creating a protocol.

If the field designates a specified protocol/project, it may include a protocol/project record identification. The user will be presented the option of maintaining the protocol/project on the system without submission; submission of the protocol/project to a protocol/project pool accessible to others; In the event the protocol/project is submitted to an accessible pool; a mechanism may be provided to prevent access to the protocol/project by specified parties in order to protect intellectual property. Access may be restricted by including a field in the protocol/project record identifying groups.

An authorized researcher may also be presented with an option of retrieving the protocol/project which is previous designed.

Resource base (208) might comprise private resource, shared resource, and commercial resource. The fields in a resource record may be populated through use of a form presented to the researcher or resource vender. The resource records advantageously includes fields specifying name and narrative fields containing descriptive information, a description of key functions, and identification of a predetermined category, a specification of term of resource according, to literature, and a description of common usage. The resource record may also include fields for a user password and a field that is used to designate the record as a submission to an accessible resource pool or a specified project.

The information in the designed protocol/project is extracted by interpreter (205) and associated with a required common name system (206). Common name is a joint name of resources/service with similar function. Interpreter (205) could be people who know the protocol/project, the relation between requirement common name and resource, and also by a program can correlate resource to requirement common name.

The Resource also associated with the requirement common name system. This association could be done by an associator (207) who could be people who know the relation between requirement common name and resource, or a program can correlate resource to requirement common name.

As a business model, especially for commercial resource, the associator (207) could be a bidding system to allow user to compete to associate resource with common name by bidding. The bidding procedure may comprise: a) select a common name for bidding, b) set resource to associate to common name c) set a price d) submit the bidding.

An interactive search will performed when a user select a protocol or project template for a project. The selection will invoke the interpreter (205) engine, which will extract the resource information required in the selected projects, find the common name (206) of the said information and use the common name to do a query in the resource database (208) and return necessary information. The information maybe resource price, resource vender and other related information.

Also an accounting system may be provided here for resource or service vendors, or even shared resources. Such an accounting system is used to accomplish deals happened in the carrying out a project.

### Projects Work Flow Optimization

According to the embodiments, a process control unit (302) will manage the flow of information through the system. A communication port (301) is provided to allow access to the network. According to the preferred embodiment, the network may include access over the internet to any number of external computer systems or access through local or wide area network to other connected computers either directly or through modems. The system will include database memory provided to store the databases.

The bases may be in the form of a data file comprised of a plurality of records, each record corresponding to a posted item. Each record will include a number of predefined fields containing parameters and additional fields containing descriptive information of the type generally used.

A user establishing access to the system according to the invention through the communication port (301) will be presented with a variety of menus. According to the preferred embodiment, communication may be effected through hypertext markup language (html) pages, ASP, PHP, JSP or other language pages.

The process control unit (302) passes information for the fields of the specified base from the user's computer through the communication port (301) into the selected database record. The bases are electronically stored databases. The bases are collection of records stored in electronically readable memory. The records advantageously includes fields specifying name, and narrative fields containing descriptive information, a description of key functions, and identification of a predetermined category, a specification of term according to literature, and a description of common usage. The fields in a record may be populated through use of a form presented to the user. The records may also include fields for a user password and a field that is used to designate the record as a submission to an accessible pool.

As discussed above, when accessing the system a user is presented with an options menu. The options menu will also include the option of submitting a protocol/project to the protocol/project database, searching the protocol/project base. As with the option of maintaining the protocol/project base, the option of searching the protocol/project base may be restricted to authorized Users selects the option of creating a protocol.

If the field designates a specified protocol/project, it may include a protocol/project record identification. The user will be presented the option of maintaining the protocol/project on the system without submission; submission of the protocol/project to a protocol/project pool accessible to others; In the event the protocol/project is submitted to an accessible pool; a mechanism may be provided to prevent access to the protocol/project by specified panics in order to protect private information. Access may be restricted by including a field in the protocol/project record identifying groups.

An authorized researcher may also be presented with an option of retrieving the protocol/project it has designed on the system.

A protocol/project may be divided into sequential steps. For each steps, the parameters may be defined so that it could be understood by a program. For example: step parameters might include:

The least gap (the minimum time required from the end of previous action to the start of next action),

The largest gap (the maximum time could be from the end of previous action to the start of next action), and

Action length (how long the action will last).

The least gap or largest gap means the gap between two actions is flexible, which is useful when merge project streamlines.

When there is more than one project carrying out at the same time, it will be possible to re-schedule the whole process to save time. The user will be provided with an option to organize the whole process. When user selects organize option, the organizer module (306) will invoke interpret engine to extract the time information contained in the project, subsequently use the extracted time information to re-schedule the project process. Since some gap might long enough to include actions of another step, the project steps could be rearranged. An example of organizes process is shown in unit 307. The each bar represents a work flow of a project. Unit 308 represents a project (1) organized in action time (A1,C1,E1) and Gap (B1,D1). Unit 309 represents another project (2) organized in action time (A2,C2,E2) and Gap (B2,D2).

As an example, if Gap B1 is big than A2, then the first step of project 2 can be done in the Gap of project 1, which saves time. According, to the preferred embodiment, an integration of the two projects produce a new workflow, which greatly saves time.

After the project process is checked and reorganized, the user may submit the project to executor module (310). The executor may be connected to a wire or wireless alarm system so that people know when to carry out the step and project manager knows the progress.

An integration of Project Design, Organizing and Carrying Out System

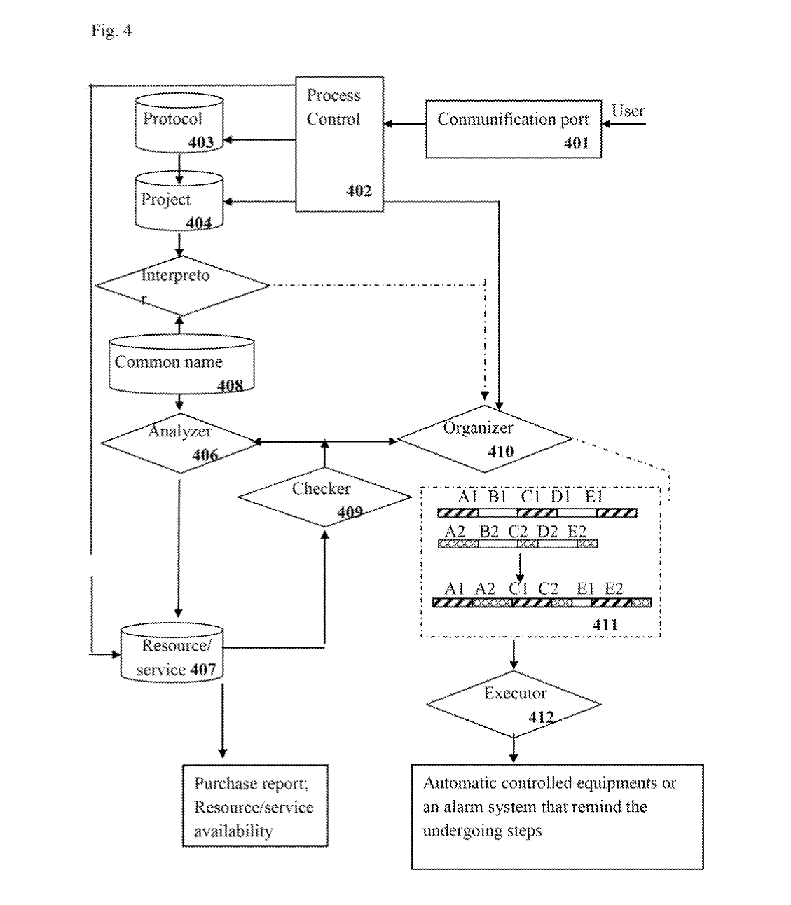

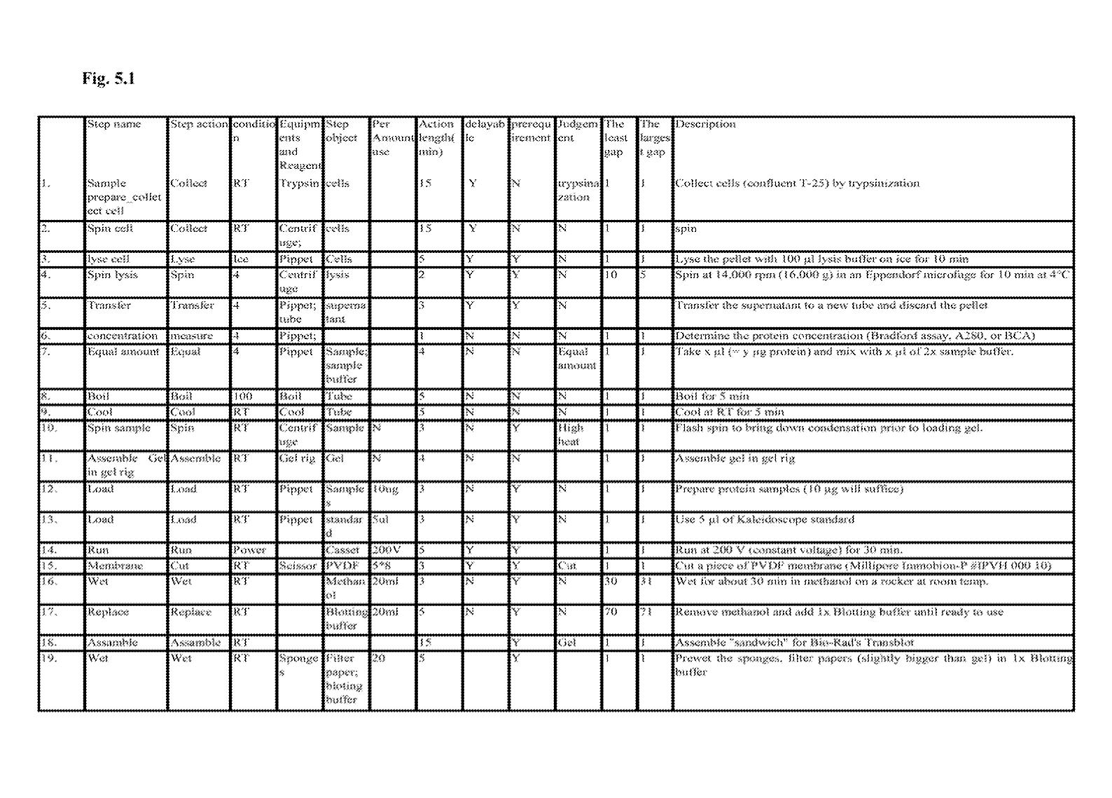

FIG. 4 shows a schematic of the system according to the invention.

According to the embodiments, a process control unit (402) will manage the flow of information through the system. A communication port (401) is provided to allow access to the network. According, to the preferred embodiment, the network may include access over the internet to any number of external computer systems or access through local or wide area network to other connected computers either directly or through modems. The system will include database memory provided to store the databases,

The bases may be in the form of a data file comprised of a plurality of records, each record corresponding to a posted item. Each record will include a number of predefined fields containing parameters and additional fields containing descriptive information of the type generally used.

It is contemplated that users accessing the system by computer communications will be researchers, resource venders or project service providers.

A user establishing access to the system according to the invention through the communication port (401) will be presented with a variety of menus. According to the preferred embodiment, communication may be effected through hypertext markup language (html) pages, ASP, PHP, JSP or other language pages.

The process Control unit (402) passes information for the fields of the specified base from the user's computer through the communication port (401) into the selected database record. The bases are electronically stored databases. The bases are collection of records stored in electronically readable memory. The records advantageously includes fields specifying name, and narrative fields containing descriptive information, a description of key functions, and identification of a predetermined category, a specification of term according to literature, and a description of common usage. The fields in a record may be populated through use of a form presented to the user. The records may also include fields for a user password and a field that is used to designate the record as a submission to an accessible pool.

As discussed above, when accessing the system a user is presented with an options menu. The options menu will also include, the option of submitting a protocol/project to the protocol/project database (403,404), searching the protocol/project base. As with the option of maintaining the protocol/project base, the option of searching the protocol/project base may be restricted to authorized users selects the option of creating a protocol.

If the field designates a specified protocol, it may include a protocol/project record identification. The user will be presented the option of maintaining the protocol/project on the system without submission; submission of the protocol/project to a protocol/project pool accessible to others; In the event the protocol/project is submitted to an accessible pool; a mechanism may be provided to prevent access to the protocol/project by specified parties in order to protect intellectual property. Access may be restricted by including a field in the protocol/project record identifying groups.

An authorized researcher may also be presented with an option of retrieving the protocols it has designed on the system.

A protocol/project may be divided into sequential steps. For each steps, the parameters may be defined so that it could be understood by a program or a machine, or an interpreter engine should be properly designed to understand a protocol. Both approaches might be used to improve performance.

An example of parameters maybe following fields included in each step:
i. Protocol/project step id (the sequential number of a protocol/project step);
ii. Step action (how the step is acted);
iii. Step condition (the step carry out condition);
iv. Step tool (what kind of tool or equipment is used);
v. Step object (what is operated in this step);
vi. Step material (what is needed in this step); and
vii. Step action time (how long the step action will last).

Step property parameters including:
i. Step delayable (whether this step could be delayed);
ii. Step prerequirement (whether this step need a prerequirement);
iii. The least gap (the minimum time required from the end of previous action to the start of next action);
iv. The largest gap (the maximum time could be from the end of previous action to the start of next action);
v. Delay condition (in what condition it could be delayed); and
vi. Action length (how long the action will last).

When the user chooses new project option, the user will be asked to select protocols from protocol database (403) to use in the project. The user is then presented with the option of using a previously established protocol record as a template; modifying a previously established protocol record as a template; or formulating a new protocol record as a template. The protocol record may advantageously be designated as a template for a selected kind of projects by correlating a protocol field with a certain kinds of project key words. As discussed above, the protocol record so designated may be transmitted or made available to the project designer.

The iterative search engine will be invoked when a project designer selects the protocol search option from the opening menu or when a project designer selects the protocol search option to search the protocol pool. When the iterative search engine is invoked to search the protocol base, a number of scrolls bar type menus may be presented to a user. The scroll bar menus can correspond to the various search parameters and fields of a protocol record. The menu presents predetermined options corresponding to the available entries for the various fields. The user then selects query entries from the options presented. According to an advantageous feature, fields which are not limited to predetermined entries may be queried using a key word or literal string inquiry. The query will return an indication of the number of records which satisfy the query. If a plurality of records is identified, additional iterations of the search may be executed. Each of the scroll bar menus is represented. However, on re-presentment, rather than displaying the entire universe of available entries for each field only the entries which correspond to entries of records selected in the previous iteration are displayed. The user can then further narrow the selections and submit additional iterative inquiries. When the query narrows selected records to the satisfaction of the user, the user may request display of predetermined portions of the selected record(s).

After selecting the protocols used in a project, other field maybe provided to define the project.

An example of fields may include:
a) Project protocol (protocol used in a project);
b) Project object (object of a project);
c) Project description (description of a project);
d) Project starting time (start time of a project); and
e) Project deadline (deadline of a project).

The fields in a project record may be populated through use of a form presented to the user. The project record may also include fields for a user password and a field that is used to designate the record as a submission to an accessible project pool or a specified project.

An authorized researcher may also be presented with an option of retrieving the projects it has designed on the system. Access may be restricted by including a field in the project record identifying groups. The designed project might be saved as project template so that a user may use it directly without start from the beginning.

The information in the designed protocol/project is extracted by interpreter (405) and associated with a required common name system (408). Common name is a joint name of resources/service with similar function. Interpreter (405) could be people who know the protocol/project, the relation between requirement common name and resource, and also by a program can correlate resource to requirement common name.

Resource base (407) might comprise private resource, shared resource, and commercial resource. The fields in a resource record may be populated through use of a form presented to the researcher or resource vender. The resource records advantageously includes fields specifying name and narrative fields Containing descriptive information, a description of key functions, and identification of a predetermined category, a specification of term of resource according to literature, and a description of common usage. The resource record may also include fields for a user password and a field that is used to designate the record as a submission to an accessible resource pool or a specified project.

The Resource also associated with the requirement common name system. This association could be done by an analyzer (406) which could be people who know the relation between requirement common name and resource, and also by a program can correlate resource to requirement common name.

As a business model, especially for commercial resource, the analyzer (406) may contain a bidding system to allow user to compete to associate resource with common name by bidding. The bidding procedure may comprise: a) select a common name for bidding, b) set resource to associate to common name c) set a price d) submit the bidding.

An interactive search will performed when a user select a protocol or project template for a project. The selection will invoke the interpreter (405) engine, which will extract the resource information required in the selected projects, find the common name (408) of the said information and use the common name to do a query in the resource database (407) and return necessary information. The information maybe resource price, resource vender and other related information.

After project is designed, the user will, be provided with an option to check the project. When user selects check option, it will invoke Checker module (409) to go through the whole project process and make an iterative search to make sure everything required for the project is ready.

When there is more than one project carrying out at the same time, it will be possible to rearrange the whole process to save time. The user will be provided with an option to organize the whole process. When user selects organize option, the organizer module (410) will invoke interpret engine to extract the time information contained in the project, subsequently use the extracted time information to re-organize the project process. Since some gap might long enough to include actions of another step, the project steps could be rearranged. An example of organizes process is shown in unit 411. The each bar represents a work flow of a project. Unit 108 represents a project (1) organized in action time (A1,C1,E1) and Gap (B1,D1) Unit 109 represents another project (2) organized in action time (A2,C2,E2) and Gap (B2,D2).

As an example, if Gap B1 is big than A1, then the first step of project 2 can be done in the Gap of project 1, which saves time. According to the preferred embodiment, an integration of the two projects produces a new workflow, which greatly saves time.

After the project process is checked and reorganized, the user may submit the project to executor module (412). The executor may be connected to a wire or wireless alarm system so that project manager knows the progress. The executor may also connect to a machine that allows automatically project carry out.

It is to be understood that the system is not limited to using the physical file, record and field structures described herein and other physical structures which are logically equivalent will be equivalent for the purpose of this invention.

The system has been described with reference to a preferred embodiment particularly suited for project design; managing the submission of protocols; and managing project database. It is to be understood that the system according to the invention is suitable for other applications including the management of other types of project management.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of assisting the design and store of a research project which comprises a plurality of steps, the method comprising;
defining a sequence of predetermined protocol steps to be used by a researcher;
in a first step, generating predetermined first prompts to guide the researcher to enter a protocol data corresponding to the first prompts;
storing the entered protocol data in a first database having a structure which is at least partially predetermined;
in a second step, generating, second prompts to guide the researcher to enter a project data corresponding to the second prompts, and determining requirements for the retrieval of data from the first database;
automatically retrieving selected protocol data from the first database, at least partially according to requirements of the second step;
storing the selected protocol data and the project data in a second database for use in at least one further step of the method; and
generating a project report including at least a portion of the selected protocol data and the project data.

2. The method according to claim 1, wherein the first prompts include prompts for information on one or more of the following:
1) the source of the protocol data,
2) identification of the protocol data.
3) authors of the protocol data, and
4) dates of publication of the protocol data.

3. The method according to claim 1, wherein the first prompts include prompts for information on protocol steps, including one or more of the following:
1) step description;
2) step tips; and
3) resources name.

4. The method according to claim 1, further comprising entering at least one user-defined first prompt.

5. The method according to claim 1, wherein the step of generating the second prompts comprises the step of guiding the researcher to enter project data corresponding to the second prompts, the project data being stored in the second database.

6. The method according to claim 1, wherein the second prompts are selected from prompts for information on the project details including one or more of the following:)
1) the project description,
2) the project objectives,
3) the project leader, and
4) research subject.

7. The method according to claim 1, wherein the second prompts are selected from prompts for information on the project steps details, including one or more of the following:
1) project step results, and
2) resource used and details.

8. The method according to claim 1, wherein the project report which is generated, including at least a portion of the selected protocol data and the project data, is compiled as a project results report for presentation to a project manager.

9. A method of assisting and determining resources to be used in a research project which comprises a plurality of steps, the method comprising;
defining a sequence of predetermined protocol steps to be used by a researcher;
in a first step, generating predetermined first prompts to guide the researcher to enter protocol data corresponding to the first prompts;
storing the entered protocol data in a first database having a structure which is at least partially predetermined;
in a second step, generating predetermined second prompts to guide the researcher to enter resource data corresponding to the second prompts;
storing the entered resource data in a second database having a structure which is at least partially predetermined;
in a third step, generating third prompts to guide the researcher to enter project data corresponding to the third prompts, and determining requirements for the retrieval of data from the first database;
automatically retrieving, selected, protocol data from the first, database, at least partially according to requirements of the third step;
using the selected protocol data to query the resource data, and display related resource records;
storing the selected protocol data, resource data and the project data in a third database for use in at least one further step of the method; and
generating a project report including at least a portion of the selected protocol data and the project data.

10. The method according to claim 9, wherein the first prompts include prompts for information on one or more of the following:
1) the source of the protocol data,
2) identification of the protocol data,
3) authors of the protocol data, and
4) dates of publication of the protocol data.

11. The method according to claim 9, wherein the first prompts include prompts for information on protocol steps, including one or more of the following:
1) step description;
2) step tips; and
3) resources name.

12. The method according, to claim 9 further comprising entering at least one user-defined first prompt.

13. The method according to claim 9, wherein the step of generating the second prompts comprises the step of guiding the researcher to enter project data corresponding to the second prompts, the project data being stored in the second database.

14. The method according to claim 9, wherein the second prompts are selected from prompts for information on the project details including one or more of the following:
1) the project description,
2) the project objectives,
3) the project leader, and
4) research subject.

15. The method according to claim 9, wherein the second prompts are selected from prompts for information on the project steps details, including one or more of the following:
1) project step results, and
2) resource used and details.

16. The method according to claim 9, wherein the project report which is generated, including at least a portion of the selected protocol data and the project data, is compiled as a project results report for presentation to a project manager.

17. A system for facilitating project design, organize, execute and experiment automation comprising:
a component formatting protocols projects into steps, define each step with step property parameters, the parameters include one or more of the following:
1. step delayable;
2. step delay condition if delayable;
3. step pre-requirement;
4. the least step gap;
5. the largest step gap; and
6. action time,
formatting the information in the step and define each step with step information parameters, the parameters further including one or more of the following:
1. resource required in carrying out a step;
2. action need;
3. act condition;
4. tools required; and
5. step description,
storing the formatted information into an electronically readable memory, refer to as protocols/projects databases,
a communication port suitable for transmitting and receiving data and instructions in the form of electrical signals, to and from remote computers or equipment,
a database manager for creating and revising records of databases connected to said electronically readable memory responsive to a plurality of said remote computers,
an interactive database query engine connected to said memory, said engine configured to permit an initial search and at least one subsequent search where said subsequent search operates on the results of said first search and any previous search, and
a process controller, connected to said database manager, said iterative database query engine and said communication port.

18. The system according to claim 17, further comprising a system to design projects by using the formatted protocols, and store projects into an electronically readable memory as project database. 19, The system according to claim 18, wherein said projects database further comprises a project formation system The said project formation system includes at least one of following parameters: 1, protocol used 2, study project; 3, project start time; 4, project deadline; and 5, project description.

20. The system according to claim 19, further comprising a resource information database, each resource being associated with the resource required in carrying out a step.
